(19) United States
(12) Patent Application Publication
(10) Pub. No.: US 2026/0342172 A1
(43) Pub. Date: Oct. 29, 2026

(54) ROTOR SHAFT WITH INTEGRATED COOLING CHANNELS

(71) Applicant: Walter Henrich GmbH, Daaden (DE)

(72) Inventors: Thorsten ELLERSIEK, Werther (DE); Uwe STEINMETZ, Steinebach/Sieg (DE)

(73) Assignee: Walter Henrich GmbH, Daaden (DE)

(21) Appl. No.: 19/107,330

(22) PCT Filed: Nov. 9, 2022
(86) PCT No.: PCT/EP2022/081331

§ 371 Date: Feb. 27, 2025

(30) Foreign Application Priority Data
Aug. 29, 2022 (EP) 22192651.2

(51) Int. Cl. H02K 7/00; H02K 1/32

(52) U.S. Cl. CPC H02K 7/003; H02K 1/32; H02K 2213/03

(57) ABSTRACT

The present disclosure relates to a rotor shaft for a rotor of an electric machine. The rotor shaft comprises an outer sleeve, an inner sleeve arranged inside the outer sleeve and two coolant distribution elements each arranged on one end of the rotor shaft. The outer sleeve has an internal profile with a multiplicity of longitudinal grooves. As an alternative or in addition, the inner sleeve has an external profile with a multiplicity of longitudinal grooves. The internal profile of the outer sleeve and/or the external profile of the inner sleeve define a multiplicity of cooling channels through which a coolant is able to flow along the rotor shaft from one coolant distribution element to the other coolant distribution element. The present disclosure furthermore relates to a rotor of an electric machine comprising the disclosed rotor shaft and to an associated electric machine.

### 1. TECHNICAL FIELD

The present disclosure relates to a rotor shaft for electric machines such as electric motors or generators with integrated cooling ducts.

### 2. PRIOR ART

Rotor shafts of rotating electric machines, for example of an electric motor or of a generator, heat up during their use. The resulting heat can be transmitted, for example, to the stator and/or rotor windings. This can lead to undesired material deformation and reduce the efficiency of the electric machine. In order to prevent this, the heating can be counteracted by passive or active cooling. An example of this is air cooling, in which air is guided over and/or through the electric machine. Another approach is the active cooling of the rotor via a liquid cooling medium.

Different rotor shafts with active cooling are known from the prior art.

For example, DE 10 2019 207 325 A1 describes a cooling arrangement for a heat-generating rotating component of an electric machine: A rotatably mounted hollow shaft which is connected to the rotor shaft in a rotationally fixed manner has at least one cooling duct for cooling lubricant, wherein the at least one cooling duct comprises a hollow shaft duct, a supply duct and an outlet duct.

US 2020/0251963 A1 describes an electric machine which comprises a single-piece hollow rotor shaft, through which a liquid coolant can flow and in the interior of which a multiplicity of heat dissipation ribs are located.

DE 10 2016 202 416 B4 discloses a rotor shaft arrangement for a rotor of an electric motor, which has a hollow shaft for receiving a rotor body and a heat sink which is arranged in the hollow shaft, the heat sink having radially extending cooling ribs and being in thermal contact radially with the hollow shaft. The heat sink has an axially continuously open structure, with the result that a cooling medium can flow axially through the heat sink in the hollow shaft, wherein the open structure is formed by defined ducts.

DE 10 2017 112 348 A1 relates to an electric machine which comprises a rotor which is rotatable with respect to a stator and has at least one rotor shaft, and a duct system, through which a coolant can flow, for cooling the machine. The duct system runs at least in sections within the rotor shaft. In this case, the duct system comprises a cooling duct which is designed to run conically at least in sections in the longitudinal direction of the rotor shaft, with the result that the coolant can be conveyed by a rotational movement of the rotor shaft in the direction of an increasing duct diameter.

Further rotor shafts known from the prior art are described in DE 11 2010 004 773 T5, U.S. Pat. No. 9,148,041 B2, EP 3 384 581 B1, DE 10 2017 112 348 A1, DE 10 2020 207 431 A1, EP 3 507 889 B1, DE 10 2019 108 943 A1, EP 3 555 992 B1, EP 3 598 611 A1, EP 3 961 875 A1, U.S. Pat. No. 7,579,725 B2, EP 1 953 896 B1, DE 10 2017 202 356 A1, U.S. Pat. No. 9,331,552 B2. EP 3 303 039 B1, EP 3 673 568 B1, EP 3 501 085 B1, DE 10 2016 209 173 A1, EP 3 152 819 B1, DE 10 2016 208 770 B4 and EP 3 433 919 B1.

### 3. SUMMARY OF THE DISCLOSURE

However, the rotor shafts known from the prior art have some disadvantages. In particular, some of the rotor shafts known from the prior art can be produced only with a high expenditure of work, material wear and consequently high costs. Furthermore, the cooling approaches known from the prior art are often insufficient, in particular for use in compact electric motors with a high power density.

Some of the known rotor shaft cooling structures are also of complex, delicate and/or multi-part design, which can result in increased waste in production and a shorter product life.

The present application is therefore based on the problem of at least partially reducing some of the described disadvantages of the prior art. This problem is at least partially solved by the subject matter of the independent claim. Exemplary embodiments are described in the dependent claims. Unless stated otherwise, material properties are to be determined in accordance with the relevant standards.

In one embodiment, the present disclosure provides a rotor shaft for a rotor of an electric machine. The rotor shaft comprises a casing tube, an inner tube which is arranged in the interior of the casing tube, and two cooling medium distribution elements. The cooling medium distribution elements are each arranged at one end of the rotor shaft. Here, the casing tube has an inner profile with a plurality of longitudinal grooves and/or the inner tube has an outer profile with a plurality of longitudinal grooves. Furthermore, the inner profile of the casing tube and/or the outer profile of the inner tube define a plurality of cooling ducts through which a cooling medium can flow from one of the cooling medium distribution elements along the rotor shaft to the other cooling medium distribution element.

The cooling medium distribution elements can, as described below, be configured in some embodiments as end plugs.

In a further exemplary embodiment, the rotor shaft comprises a casing tube which has an inner profile with a plurality of longitudinal grooves, an inner tube which is arranged in the interior of the casing tube, and a first and a second cooling medium distribution element or a first and second end plug which are each connected to one end of the casing tube in a form-fitting and force-fitting or form-fitting and integrally bonded manner by engaging in a part of the plurality of longitudinal grooves; wherein the inner profile of the casing tube and the outer side of the inner tube define a plurality of cooling ducts through which a cooling medium can flow along the casing tube.

A form-fitting and force-fitting or a form-fitting and integrally bonded connection also comprises a combined form-fitting, force-fitting and integrally bonded connection in the context of this application.

The above-described tube-in-tube construction makes it possible to significantly simplify the construction and the production of an actively cooled rotor shaft and at the same time improve the cooling. Furthermore, high torques can be transmitted via the form-fitting and force-fitting between the profiled casing tube and the cooling medium distribution elements/end plugs and at the same time the cooling ducts can be defined along the longitudinal grooves of the casing tube inner profile and/or of the outer profile of the inner tube.

This simplification of the construction of the rotor shaft entails a number of advantages: no additional element for transmitting torque is required, as a result of which material and weight can be saved. The dual function of the inner profile of the casing tube, firstly in the definition of the axially running cooling ducts and secondly in the form-fitting and force-fitting by interlocking with the cooling medium distribution elements, makes it possible to produce the casing tube with a low expenditure of work and separately from the other components of the rotor shaft.

The inner tube and casing tube can be cold-formed, for example drawn, metal tubes which are produced, for example, from common materials such as E355 and 42CrMo4, structural steels, heat-treatment steels and/or case-hardened steels.

The cooling medium distribution elements can be produced, for example, by forging or additive manufacturing or machining. As a result, the production method of the casing tube can be changed in a simple and expedient manner in order to produce casing tubes in modified embodiments for new rotor shafts, for example with different lengths, different diameters, different thicknesses and/or different types and depths of the profiling. In particular, one or both cooling medium distribution elements can be used directly for torque transmission by the form-fitting or force-fitting connection to the casing tube or the inner profile of the casing tube, which significantly simplifies the construction of the rotor shaft.

In order to further save weight production complexity, the casing tube can have, at one end (or both), a taper which is designed to receive one of the cooling medium distribution elements (or both) in the interior of the casing tube and to function as a fit or bearing seat for a rotary bearing of the electric machine or to comprise such a fit or bearing seat (cf. FIGS. 11 to 13B). In such embodiments, the cooling medium distribution element which is arranged in the interior of the taper can be produced from a low-weight material such as, for instance, a plastic (e.g. PEEK). The inner tube can also be produced from such a material.

Furthermore, at least one of the two cooling medium distribution elements of the rotor shaft can have a torque transmission element. As a result of this arrangement, the production of the other components of the rotor shaft, i.e. of the casing tube, of the inner tube, of the other cooling medium distribution element and, if appropriate, of a cooling medium guide tube, remains uninfluenced by the specific embodiment of the torque transmission element.

In order to simplify the production of the casing tube—for example via axial cold forming or cold drawing of tubes—and the connection to the cooling medium distribution elements, the inner profile of the casing tube along the circumference of the casing tube can have periodically repeating—for example sinusoidal—elevations and depressions. In addition, the cooling medium can thereby be distributed uniformly for cooling in the rotor shaft.

In order to realize a form-fitting connection of inner tube and casing tube for defining the cooling ducts in a simple manner, the inner tube can engage in a part of the plurality of longitudinal grooves. As a result of this arrangement, undesired positioning and/or rotation of the inner tube and of the casing tube relative to one another is not possible. Furthermore, inner tube and outer tube can be connected in this arrangement in a material-saving and work-saving manner. In addition, the cooling medium is thus distributed uniformly for cooling the rotor shaft via the rotor shaft.

In other embodiments, one or both of the cooling medium distribution elements can be welded in a rotationally fixed manner to the casing tube without engaging in the longitudinal grooves.

Furthermore, the inner tube can have a cross section with elevations and depressions periodically repeating along its circumference, wherein the elevations of the inner tube engage in a part of the longitudinal grooves of the inner profile of the casing tube (see also FIGS. 1A and 3B). The periodically repeating elevations of the inner tube, like the possible periodic profiling of the casing tube, permit uniform distribution of the cooling medium for cooling the rotor shaft. Furthermore, such periodic profiling of the inner tube and of the casing tube can facilitate assembly since, owing to the symmetry, there are a plurality of relative positions in which the two profiles engage in one another.

In one possible embodiment, the casing tube has a maximum wall thickness in the range from 2.00 mm to 10.00 mm and/or the inner tube has a wall thickness in the range from 0.5 mm to 5.00 mm. These thickness ranges make it possible, firstly, to ensure high structural stability for transmitting high torques and, secondly, to produce material-saving components. In this thickness range, the same production method can be used for different embodiments, for example but not exclusively for tubes of different thicknesses, profiles or lengths, with minor and expedient adaptations being made.

Furthermore, in one possible embodiment, the inner profile of the casing tube can have a profile depth in the range from 1.00 mm to 6.00 mm, preferably in the range from 1.5 mm to 3.5 mm, and/or the inner tube can have a profile depth in the range from 0.5 mm to 4.00 mm, preferably in the range from 1.5 mm to 3.5 mm. Profile depths in these ranges are distinguished in that the flow behavior of the cooling medium can be set advantageously with regard to laminar or turbulent dynamics and in accordance with the requirements of the respective system. In addition, such profile depths can ensure sufficient rotational strength for the cooling medium distribution elements in order to be able to transmit high torques. In particular, such profile depths can ensure that turbulences can form despite a high mass flow of the cooling medium, which optimizes the efficiency of the cooling.

In order to improve the connection of the cooling medium distribution elements to the casing tube, in one possible embodiment one or both of the cooling medium distribution elements can have an outer profile which engages in the inner profile of the casing tube and/or the cooling medium distribution elements can be pressed to the casing tube. The interlocking of the outer profile of the cooling medium distribution elements with the inner profile of the casing tube uses an advantageous embodiment of the form-fitting using the existing profiling of the casing tube for defining the cooling ducts. This type of form-fitting saves material since no further fastening means are necessary and it saves work in production. Alternatively or additionally, the cooling medium distribution elements can also be welded to the casing tube.

In order to guide the cooling medium through the cooling ducts defined by the inner tube and the casing tube, in some embodiments the cooling medium distribution elements can each have a cooling medium distribution structure which is connected to one of the cooling ducts defined via the inner profile of the casing tube and the outer side of the inner tube. As a result, no additional cooling medium supply is necessary which would complicate the construction of the rotor shaft and the production of the casing tube and of the inner tube remains largely uninfluenced by the specific embodiment of the cooling medium supply. In addition, the positioning of the cooling medium distribution structure in the cooling medium distribution elements allows different architectures of the cooling medium guidance through the rotor shaft (see FIGS. 4A, 4B and 4C and also FIGS. 12A, 12B and 12C) and, if appropriate, by further elements attached to the rotor shaft (see FIGS. 5A and 5B and also FIGS. 13A and 13B), such as elements for electromagnetic force transmission, such as, for example, by a rotor laminated core with permanent magnets or with rotor windings.

For reasons of accessibility for inflow and outflow devices depending on the arrangement of the rotor shaft, it may be advantageous for the cooling medium guidance if, in some embodiments, one of the cooling medium distribution elements has an inflow for the cooling medium which is connected to the cooling medium distribution structure and the other cooling medium distribution element has an outflow for the cooling medium which is connected to the cooling medium distribution structure (see FIGS. 4B and 5B and also FIGS. 12A and 12B).

Alternatively, it may also be advantageous in other possible fields of application if, in other embodiments, a cooling medium guide tube is arranged within the inner tube and connects the two cooling medium distribution elements to one another in such a way that the cooling medium can flow from one cooling medium distribution element to the other through the cooling medium guide tube and one of the cooling medium distribution elements has an inflow and an outflow for the cooling medium, wherein the outflow is connected to the cooling medium distribution structure and the inflow is connected to the cooling medium guide tube (see FIGS. 4A, 4C and 5A and also FIGS. 12A, 12C and 13A) or vice versa.

In one possible embodiment of the rotor shaft, the cooling medium distribution element, which has the inflow for the cooling medium, also has the torque transmission element (see FIGS. 4A, 5A, 12A and 13A). This arrangement can be combined advantageously, for example if the inflow for the cooling medium is located coaxially in the interior of the torque transmission element. In general, the individual components can thus be arranged in a space-saving and material-saving manner.

In a further embodiment of the rotor shaft, the cooling medium distribution element, which has the torque transmission element, has no external inflows or outflows for the cooling medium (see FIGS. 4C and 12C), which permits more compact drive systems.

The present application furthermore relates to a rotor for an electric machine which comprises a rotor shaft as described above and an element for electromagnetic force transmission which is connected in a rotationally fixed manner, preferably in a force-fitting manner, to a part of the outer surface of the casing tube. The element for electromagnetic force transmission is thus located in the vicinity of the cooling ducts in the casing tube, which can have an advantageous effect on the temperature in the element for electromagnetic force transmission. In addition, a further support element for fastening the element for electromagnetic force transmission is thus not required. The element for electromagnetic force transmission can thus also be cooled via the rotor cooling, which improves the efficiency of the machine, in particular in the case of non-permanently excited machines, such as asynchronous machines.

In order to improve the cooling of the element for electromagnetic force transmission, it may be advantageous if the element for electromagnetic force transmission also has at least one cooling duct which is connected to the cooling medium distribution structure of the two cooling medium distribution elements (see FIGS. 5A and 5B and also FIGS. 13A and 13B). The heating of the entire rotor can thus be counteracted and an even higher efficiency can be achieved.

The present application furthermore relates to an electric machine which comprises a stator and a rotor as described above.

### 4. BRIEF DESCRIPTION OF THE DRAWINGS

The drawings show:

FIG. 1A a side view of the components of a rotor shaft according to an exemplary embodiment of the present disclosure;

FIG. 1B a side view of the assembled rotor shaft of FIG. 1A;

FIG. 2A a side view of a first end plug according to a possible embodiment of the present disclosure;

FIG. 2B a side view of the first end plug of FIG. 2A;

FIG. 2C a side view of a second end plug according to a possible embodiment of the present disclosure;

FIG. 2D a side view of the second end plug of FIG. 2C;

FIG. 3A a cross-sectional view of a rotor shaft according to a possible embodiment with a round inner tube without profiling;

FIG. 3B a cross-sectional view of a rotor shaft according to a possible embodiment with a profiled inner tube, wherein the elevations of the profiling of the inner tube engage in some of the depressions of the inner profile of the casing tube;

FIG. 4A a longitudinal section through a rotor shaft according to an embodiment with additional coolant guide tube;

FIG. 4B a longitudinal section through the rotor shaft according to an embodiment, without additional coolant guide tube;

FIG. 4C a longitudinal section through a rotor shaft according to a further embodiment with additional coolant guide tube;

FIG. 5A a longitudinal section of a rotor shaft with coolant guide tube and additional cooling ducts in an element for electromagnetic force transmission;

FIG. 5B a longitudinal section of a rotor shaft without additional coolant guide tube and additional cooling ducts in an element for electromagnetic force transmission;

FIG. 6 an electric machine according to a possible embodiment with a rotor as described herein and a stator;

FIG. 7A a side view of the components of a rotor shaft according to an exemplary embodiment of the present disclosure with a pressed-in coolant distribution element/end plug, a tapering casing tube and a coolant distribution element arranged within the taper;

FIG. 7B a side view of the components of a rotor shaft according to an embodiment of the present disclosure with a welded coolant distribution element/end plug, a tapering casing tube and a coolant distribution element arranged within the taper;

FIG. 7C a side view of the assembled rotor shaft of FIG. 7A or 7B;

FIG. 8 a side view of the first end plug of FIG. 7B;

FIG. 9A a side view of a tapering casing tube according to an embodiment with an inner profile with helically extending longitudinal grooves;

FIG. 9B an inner view of the tapering casing tube of FIG. 9A;

FIG. 9C a plan view of a casing tube according to an embodiment with an inner profile with helically extending longitudinal grooves;

FIG. 10A a cross-sectional view of a rotor shaft according to a possible embodiment with a profiled inner tube with a cross section with three-fold rotational symmetry, wherein the elevations of the profiling of the inner tube engage in some of the depressions of the inner profile of the casing tube, with a cross section with three-fold rotational symmetry;

FIG. 10B a cross-sectional view of a rotor shaft according to a possible embodiment with a hexagonal inner tube and an outer tube, the inner profile of which is configured to bear with its elevations against the outer side of the inner tube;

FIG. 11 a side view of the components of a rotor shaft according to an embodiment of the present disclosure with a pressed-in end plug, an inner tube with an outer profile and a tapering outer tube without an inner profile;

FIG. 12A a longitudinal section through a rotor shaft according to an embodiment with tapering casing tube and additional coolant guide tube;

FIG. 12B a longitudinal section through the rotor shaft according to an embodiment with tapering casing tube and without additional coolant guide tube;

FIG. 12C a longitudinal section through a rotor shaft according to a further embodiment with tapering casing tube and additional coolant guide tube;

FIG. 13A a longitudinal section of a rotor shaft with tapering casing tube, a coolant guide tube and additional cooling ducts in an element for electromagnetic force transmission;

FIG. 13B a longitudinal section of a rotor shaft with tapering casing tube, without additional coolant guide tube and additional cooling ducts in an element for electromagnetic force transmission.

### 5. DETAILED DESCRIPTION OF SOME EMBODIMENTS

Some exemplary embodiments of the present disclosure are described below using the example of some exemplary rotor shafts for electric machines. Various combinations of features are described here with reference to the illustrated embodiments. Of course, not all the features of the described embodiments have to be present in order to realize the present invention. Furthermore, the embodiments can be modified by combining certain features of one embodiment with one or more features of another embodiment—if this is technically compatible and expedient—without departing from the disclosure and the scope of protection of the present invention, which is defined by the claims.

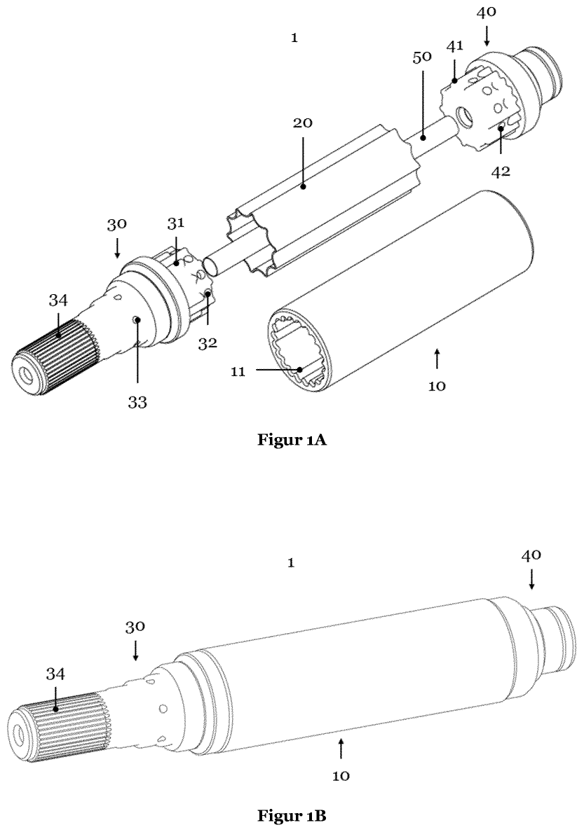

FIG. 1A shows a side view of the components of a rotor shaft 1 according to a possible embodiment of the present disclosure. The latter comprises a casing tube 10, for example with a wall thickness in the range from 2.00 mm to 10.00 mm, with a periodic inner profile 11, which in the illustrated embodiment has a plurality of axially extending longitudinal grooves. The illustrated embodiment additionally comprises an inner tube 20, for example with a wall thickness of 0.5 mm to 5.00 mm, a first end plug or cooling medium distribution element 30, a second end plug or cooling medium distribution element 40 and a cooling medium guide tube 50. The first end plug 30 can have an outer profile 31 and the second end plug 40 can have an outer profile 41. In the illustrated embodiment, the second end plug 40 has a cooling medium distribution structure 42 for the inflow of the cooling medium and the first end plug 30 has the cooling medium distribution structure 32, 33 for the outflow of the cooling medium. In the illustrated embodiment, the first end plug 30 further has a torque transmission element 34, via which the rotor shaft 1 can be connected, for example, to a wheel, propeller, transmission or the like to be driven. Other corresponding embodiments can comprise, for example, other inner profiles 11 of the casing tube 10 and outer profiles 31, 41 of the end plugs 30, 40, other cooling medium distribution structures 32, 33, 42 and/or other torque transmission elements 34 and/or can dispense with the use of a cooling medium guide tube 50.

FIG. 1B shows a side view of the rotor shaft 1 according to a possible embodiment, assembled from the components described in FIG. 1A, in which the casing tube 10 is connected in a form-fitting and force-fitting manner to the first end plug 30 and the second end plug 40, wherein the first end plug 30 can have a torque transmission element 34. The connection between casing tube 10 and end plugs 30, 40 can be effected, for example, by pressing the end plugs 30, 40 to the casing tube 10, wherein the first end plug 30 and the second end plug 40 each engage in a part of the plurality of longitudinal grooves of the inner profile 11 of the casing tube 10, for example such that the elevations of the outer profiles 31, 41 engage in the inner profile 11. The inner tube 20 and the cooling medium guide tube 50 are located, not visible in this view, coaxially with the casing tube 10 in the interior of the casing tube 10 and at least partially between the first end plug 30 and the second end plug 40.

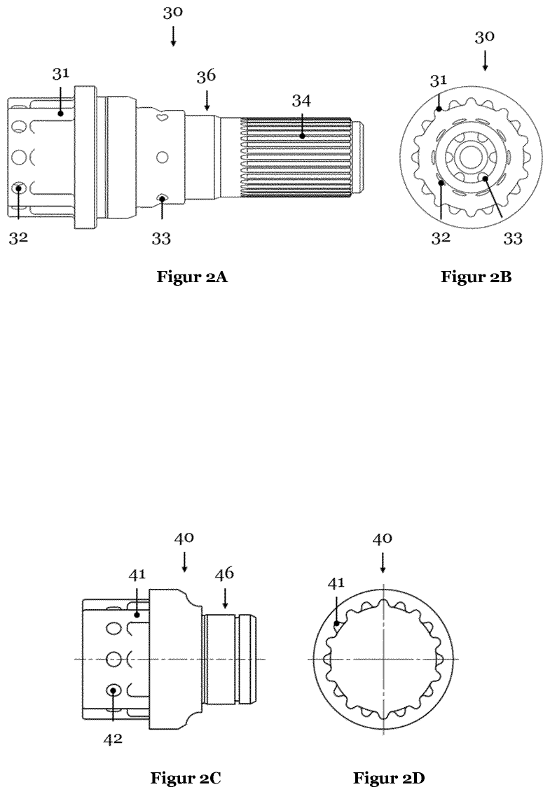

FIG. 2A shows a side view of the first end plug or cooling medium distribution element 30 according to a possible embodiment, in which the first end plug 30 has an outer profile 31, a cooling medium distribution structure 32, 33 and a torque transmission element 34. In this exemplary embodiment, the outer profile 31 of the first end plug 30 has longitudinal elevations which run in the axial direction and have different lengths in the axial direction, with the result that the cooling medium can be introduced into the cooling medium distribution structure 32, 33 from the cooling ducts which are formed by the inner tube 20 and the longitudinal grooves. The end plug 30 furthermore has a fit 36 for a rotary bearing (for example a rolling bearing) of the electric machine.

FIG. 2B shows a further view of the first end plug 30 according to a possible embodiment with a viewing direction along the axial or longitudinal direction of the rotor shaft. The exemplary embodiment has an outer profile 31 of elevations which repeat periodically around the circumference of the first end plug 30, wherein in each case every second elevation is shorter in order to permit a fluidic connection between cooling ducts and cooling medium distribution structure 32, 33.

FIG. 2C shows a side view of the second end plug 40 according to a possible embodiment, in which the second end plug 40 likewise has an outer profile 41 and a cooling medium distribution structure 42. In this exemplary embodiment, the outer profile 41 of the second end plug 40, in a similar manner to that described above for the first end plug 30, has longitudinal elevations in the axial direction which have different lengths in the axial direction. The end plug 40 furthermore comprises a fit 46 for a rotary bearing (for example a rolling bearing) of the electric machine.

FIG. 2D shows a further view of the second end plug 40 according to a possible embodiment with a viewing direction along the axial direction. The exemplary embodiment has an outer profile 41 of elevations which repeat periodically around the circumference of the second end plug 40, wherein in each case every second elevation is shorter in order to permit a fluidic connection between cooling ducts and cooling medium distribution structure 42.

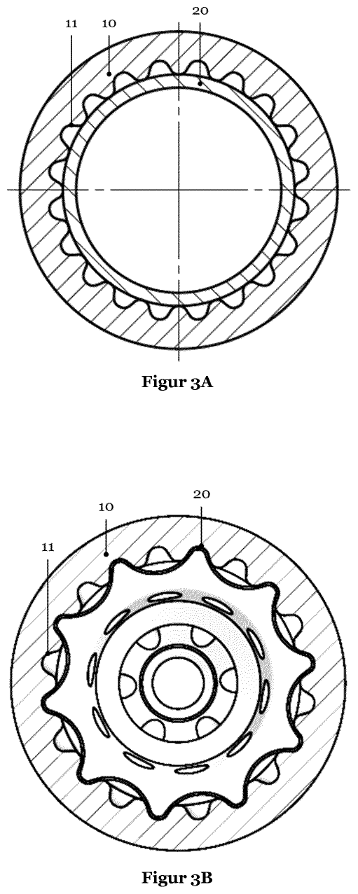

FIG. 3A shows a cross section through a rotor shaft 1 according to a possible embodiment with a round inner tube 20 without profiling in the assembled state. In this exemplary embodiment, the casing tube 10 has a sequence of axially extending elevations and depressions which repeat periodically around the circumference of the casing tube 10 and which form the inner profile 11 of the casing tube 10. The elevations of the inner profile 11 are in contact with the outer surface of the inner tube 20. The free spaces in the longitudinal grooves or depressions of the inner profile 11, delimited by the casing tube 10 and the inner tube 20, define axially extending cooling ducts for receiving a cooling medium, such as cooling water, oil or even a cooled fuel, which can then be fed to a plant for energy conversion.

In another exemplary embodiment, FIG. 3B shows a cross section through a rotor shaft 1 according to a possible embodiment with a profiled inner tube 20, wherein the elevations of the profiling of the inner tube 20 engage in some of the depressions or grooves of the inner profile 11 of the casing tube 10. In the exemplary embodiment shown, the elevations of the profile of the inner tube 20 are formed such that they engage in a form-fitting manner in every second depression of the inner profile 11 of the casing tube 10 and therefore the cooling ducts extend in every other second longitudinal groove of the inner profile 11 of the casing tube 10.

In one possible embodiment of the rotor shaft 1, the inner profile 11 of the casing tube 10 can have a profile depth in the range from 1.00 mm to 6.00 mm, preferably in the range from 1.5 mm to 3.5 mm, and the inner tube 20 can either have no profile at all (see, for example, FIG. 3A) or a profile depth in the range from 0.5 mm to 4.00 mm, preferably in the range from 1.5 mm to 3.5 mm.

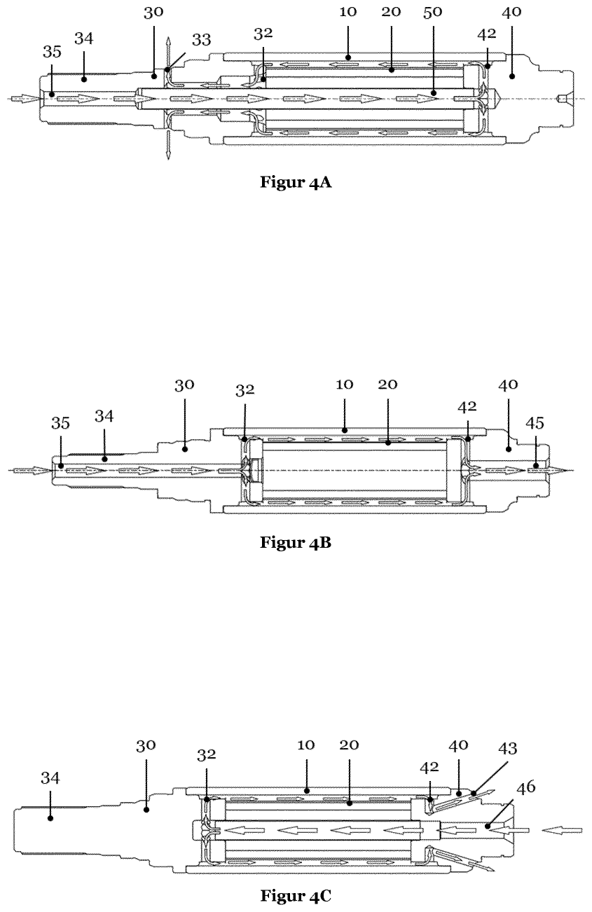

FIG. 4A shows a longitudinal section through a rotor shaft 1 according to an embodiment, in which the first end plug or the cooling medium distribution element 30 has an inflow 35 and an outflow 33 for the cooling medium. The profile of the cooling medium in the rotor shaft 1 is illustrated schematically by arrows. In the exemplary embodiment illustrated in FIG. 4A, the first end plug 30 has an inflow 35, via which the cooling medium is guided in the direction of the arrow in the interior of the first end plug 30. The cooling medium passes through the cooling medium guide tube 50, which, in the illustrated possible embodiment, connects the inflow 35 of the first end plug 30 to the cooling medium distribution structure 42 of the second end plug 40, into the cooling medium distribution structure 42 along the illustrated arrows. The latter guides the cooling medium in at least partially radially extending ducts into the axially extending cooling ducts, defined in the free spaces between the casing tube 10 and the inner tube 20. In the exemplary embodiment illustrated, the cooling ducts guide the cooling medium from the second end plug 40 back in the direction of the first end plug 30. The cooling medium distribution structure 32 of the first end plug 30 is connected to the cooling ducts and can guide the cooling medium into the interior of the first end plug 30. The second part of the cooling medium distribution structure 33 of the first end plug 30 represents the outflow for the cooling medium. In this possible embodiment, inflow and outflow of the cooling medium are therefore located at the same end plug 30, which in some embodiments also has a torque transmission element.

FIG. 4B shows a longitudinal section through the rotor shaft 1 according to another possible embodiment, in which the first end plug 30 has an inflow 35 for the cooling medium, which is connected to the cooling medium distribution structure 32, and the second end plug 40 has an outflow 45 for the cooling medium, which is connected to the cooling medium distribution structure 42 of the second end plug 40. The profile of the cooling medium in the rotor shaft 1 is once again illustrated schematically by arrows. In the illustrated embodiment, the cooling medium passes in the direction of the arrow through the inflow 35 into the interior of the first end plug 30. The inflow 35 is connected to the cooling medium distribution structure 32 of the first end plug 30, which guides the cooling medium in at least partially radially extending ducts into the axially extending cooling ducts, defined in the free spaces between the casing tube 10 and the inner tube 20. The cooling ducts guide the cooling medium from the first end plug 30 to the second end plug 40, where it can be guided from the cooling medium distribution structure 42 of the second end plug 40 to the outflow 45. In this possible embodiment, inflow and outflow of the cooling medium are therefore located at different end plugs.

FIG. 4C shows a longitudinal section through a rotor shaft 1 according to an embodiment, in which the second end plug 40 has an inflow 46 and an outflow 43 for the cooling medium. The profile of the cooling medium in the rotor shaft 1 is once again illustrated schematically by arrows. In the illustrated embodiment, the cooling medium is guided in the direction of the arrow via the inflow 46 into the interior of the second end plug 40. The cooling medium passes through the cooling medium guide tube 50, which, in the illustrated embodiment, connects the inflow 46 of the second end plug 40 to the cooling medium distribution structure 32 of the first end plug 30, into the cooling medium distribution structure 32 of the first end plug 30 along the illustrated arrows. This cooling medium distribution structure 32 guides the cooling medium in at least partially radially extending ducts into the axially extending cooling ducts, defined in the free spaces between the casing tube 10 and the inner tube 20. In the illustrated embodiment, the cooling ducts guide the cooling medium from the first end plug 30 back in the direction of the second end plug 40. The cooling medium distribution structure 42 of the second end plug 40 is also connected to the axial cooling ducts and can guide the cooling medium into the interior of the second end plug 40. The cooling medium distribution structure 42 of the second end plug 40 guides the cooling medium to an outflow 43, via which the cooling medium exits from the second end plug 40. In this possible embodiment, inflow and outflow of the cooling medium are therefore located at the second end plug 40. This has the advantage, inter alia, that the first end plug 30, which has the torque transmission element 34, requires no connections for the cooling medium, which can lead, inter alia, to improved mechanical properties of the first end plug 30 and space saving for an electric drive system—for example a direct drive for motor vehicle wheels or a drive for an aircraft propeller—in which such an actively cooled rotor shaft 1 is used.

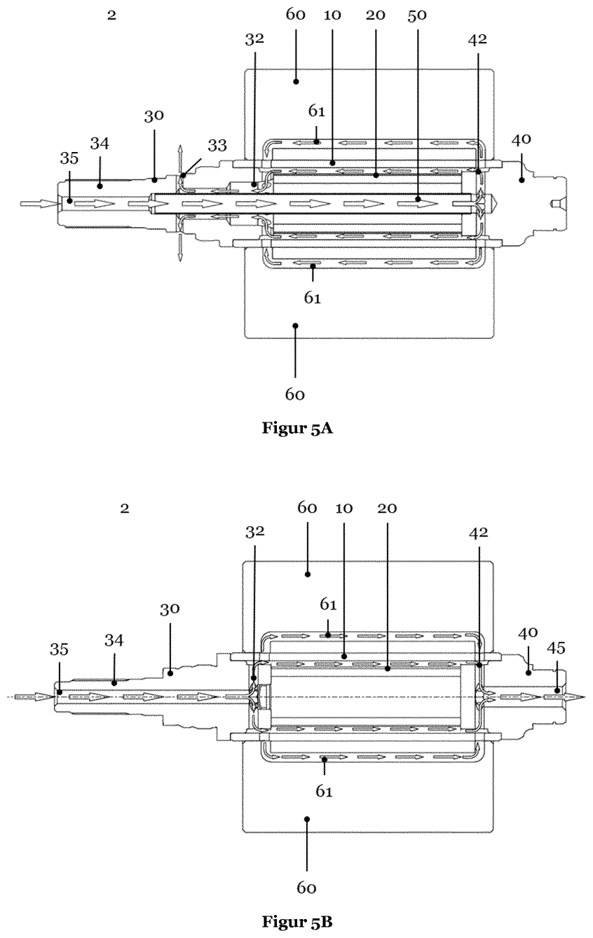

FIG. 5A shows a longitudinal section through the embodiment of a rotor shaft 1, in which the first end plug 30 has the inflow 35 and the outflow 33 for the cooling medium and an element for electromagnetic force transmission 60 (such as, for example, a laminated rotor core with permanent magnets or with rotor windings) which is connected in a rotationally fixed manner, preferably in a force-fitting manner, to a part of the outer surface of the casing tube 10. The profile of the cooling medium in the rotor shaft 1 and in the element for electromagnetic force transmission 60 is once again illustrated schematically by arrows. The rotor shaft 1 together with the element for electromagnetic force transmission 60, which can have dedicated cooling ducts 61, represents a rotor 2 of a rotating electric machine 3. In the possible embodiment illustrated in FIG. 5A, the cooling medium can pass via the inflow 35 into the first end plug 30. The cooling medium passes through a cooling medium guide tube 50, which, in the illustrated possible embodiment, connects the inflow 35 of the first end plug 30 to the cooling medium distribution structure 42 of the second end plug 40, into the cooling medium distribution structure 42 of the second end plug 40 along the illustrated arrows. The latter guides the cooling medium in at least partially radially extending ducts into the axially extending cooling ducts, defined in the free spaces between the casing tube 10 and the inner tube 20, and into the cooling ducts 61 of the element for electromagnetic force transmission 60. The cooling medium can pass via the cooling ducts from the second end plug 40 to the first end plug 30, where it can be received by the cooling medium distribution structure 32 of the first end plug 30 and guided to the outflow 33. In this possible embodiment, inflow and outflow of the cooling medium are therefore located at the same end plug.

FIG. 5B shows a longitudinal section through the embodiment of the rotor shaft 1, in which the first end plug 30 has an inflow 35 for the cooling medium, which is connected to the cooling medium distribution structure 32 of the first end plug 30, and the second end plug 40 has an outflow 45 for the cooling medium, which is connected to the cooling medium distribution structure 42, and an element for electromagnetic force transmission 60, which is connected in a rotationally fixed manner, preferably in a force-fitting manner, to a part of the outer surface of the casing tube 10. The profile of the cooling medium in the rotor shaft and in the element for electromagnetic force transmission is illustrated schematically by arrows. The rotor shaft 1 together with the element for electromagnetic force transmission 60, which can have dedicated cooling ducts 61, represents the rotor 2. The cooling medium can pass via the cooling ducts from the first end plug 30 to the second end plug 40, where it can be received by the cooling medium distribution structure 42 of the second end plug 30 and guided to the outflow 45. In this possible embodiment, inflow and outflow of the cooling medium are therefore located at different end plugs. An element for electromagnetic force transmission 60 with dedicated cooling ducts 61 can also be combined with the embodiment of FIG. 4C.

The embodiments illustrated in FIGS. 4A, 4B, 4C, 5A and 5B are possible examples of the present disclosure. Further possible embodiments can have, for example, an inflow and an outflow for the cooling medium at the second end plug 40 or have an inflow at the second end plug 40 and an outflow at the first end plug 30. Embodiments with a plurality of inflows and/or a plurality of outflows and/or embodiments with a line of the cooling medium contrary to the illustrated direction of the arrow and other embodiments which are not mentioned are also possible.

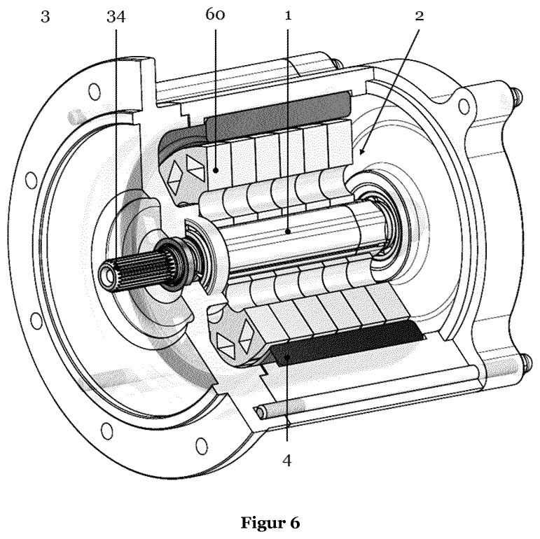

FIG. 6 shows an electric machine 3 according to a possible embodiment with a rotor 2 and a stator 4. The rotor 2, comprising a rotor shaft 1 and an element for electromagnetic force transmission 60 which is connected in a rotationally fixed manner, preferably in a force-fitting manner, to the rotor shaft 1, according to one of the exemplary embodiments described above or according to another embodiment, is rotatable with respect to the stator 4 (for example using two rolling bearings) and has a torque transmission element 34. One of the end plugs can be used for torque transmission in a possible embodiment by the form-fitting or force-fitting connection to the casing tube 10 or to the inner profile 11 of the casing tube 10.

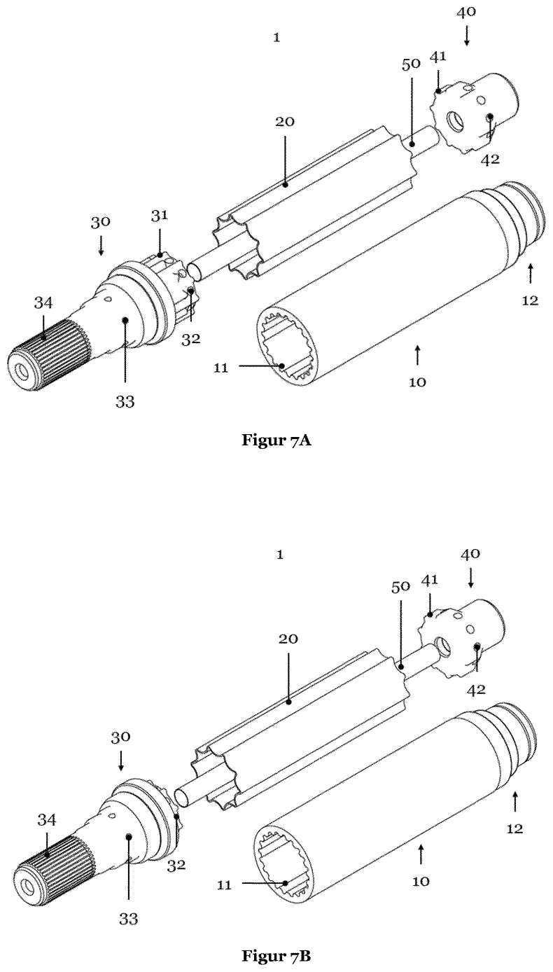

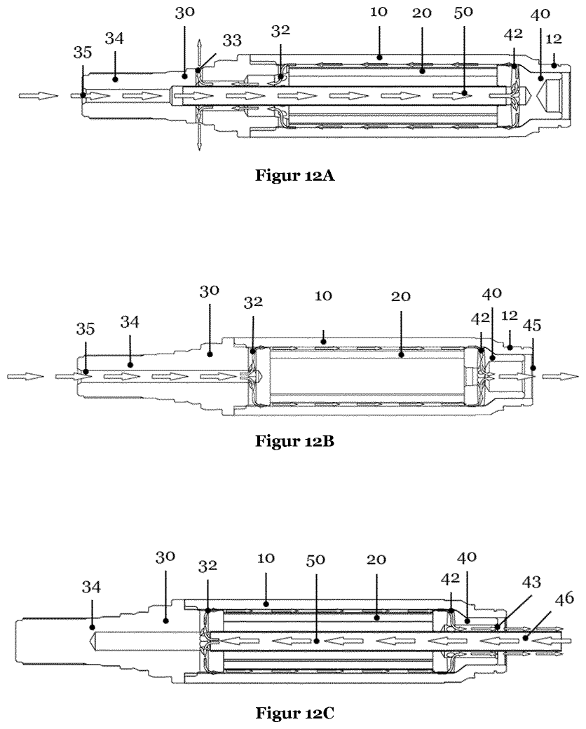

FIG. 7A shows a side view of the components of a possible embodiment of a rotor shaft 1 with a tapering casing tube 10 with an inner profile 11, a profiled inner tube 20 and a cooling medium guide tube 50. In the possible embodiment shown, the casing tube 10 tapers at one end, with the result that it has a smaller radius at the one end than over the rest of the length of the casing tube 10. In addition, the rotor shaft 1 has a first end plug 30 (i.e. a first cooling medium distribution element) and a second cooling medium distribution element 40. The first end plug 30 can have an outer profile 31 and the second cooling medium distribution element 40 can have an outer profile 41. In the illustrated exemplary embodiment, the second cooling medium distribution element 40 has a cooling medium distribution structure 42 for the cooling medium and the first end plug 30 has the cooling medium distribution structure 32, 33 for the inflow and outflow of the cooling medium (cf. FIG. 12A).

In the illustrated embodiment, the first end plug 30 further has a torque transmission element 34, via which the rotor shaft 1 can be connected, for example, to a wheel, propeller, transmission or the like to be driven. The taper 12 can be configured in such a way that the second cooling medium distribution element 40 can be at least partially received in the taper 12 of the casing tube 10. The first end plug 30 in the illustrated embodiment is configured to be pressed into the casing tube 10. Just like other embodiments described herein, the individual components can each consist, for example, of metal, non-ferrous metal, steel, ceramic, plastic, natural material and/or combinations thereof. Different components can consist of different and/or the same materials in order to optimize the respective quality, for example, with regard to the component requirements, expenditure of work and/or material costs. The formed end, in this exemplary case a taper 12, of the casing tube can replace not only, as shown in FIG. 7A, a part of the second end plug 40 in comparison with FIG. 1A.

Other possible embodiments of the casing tube 10 can have one or two formed ends which assume certain functions of at least one of the end plugs 30, 40, with the result that the respective end plug 30, 40 is an integral part of the casing tube 10 and the corresponding end plug 30, 40 is not present as a separate component. The two ends of the casing tube 10 can be different or identical.

FIG. 7B shows a side view of the components of a possible embodiment of a rotor shaft 1 with a tapering casing tube 10 with an inner profile 11, a profiled inner tube 20 and a cooling medium guide tube 50. In comparison with the embodiment of FIG. 7A, the outer profile of the end plug 30 is significantly shortened, with the result that the rotationally fixed connection between end plug 30 and casing tube 10 is not effected by means of pressing, but rather by welding or another suitable integrally bonded connection technique.

FIG. 7C shows a side view of the rotor shaft 1 according to a possible embodiment, assembled from the components described in FIGS. 7A and 7B, in which the tapering casing tube 10 is connected in a rotationally fixed manner to the first end plug or cooling medium distribution element 30, wherein the first end plug 30 can have a torque transmission element 34. The second cooling medium distribution element 40 is arranged in the interior of the tapering part 12 of the casing tube and is therefore not visible in FIG. 7C. The connection between casing tube 10 and end plug 30 can be effected, for example, by pressing and/or welding, wherein the first end plug 30 engages in a part of the plurality of longitudinal grooves of the inner profile 11 of the casing tube 10, for example such that the elevations of the outer profile 31 engage in those of the inner profile 11. The inner tube 20 and the cooling medium guide tube 50 are located, not visible in this view, coaxially with the casing tube 10 in the interior of the casing tube 10 and at least partially between the first end plug 30 and the second cooling medium distribution element 40 (also not visible). Since the rotor shaft engages in a rotary bearing of the electric machine at the tapering end 12 of the casing tube, the second cooling medium distribution element 40—unlike the first end plug 30—does not have to withstand any strong mechanical loads and can therefore—like the inner tube and the coolant guide tube—also be produced from a favourable and lightweight material such as a suitable plastic (e.g. PEEK) or aluminum.

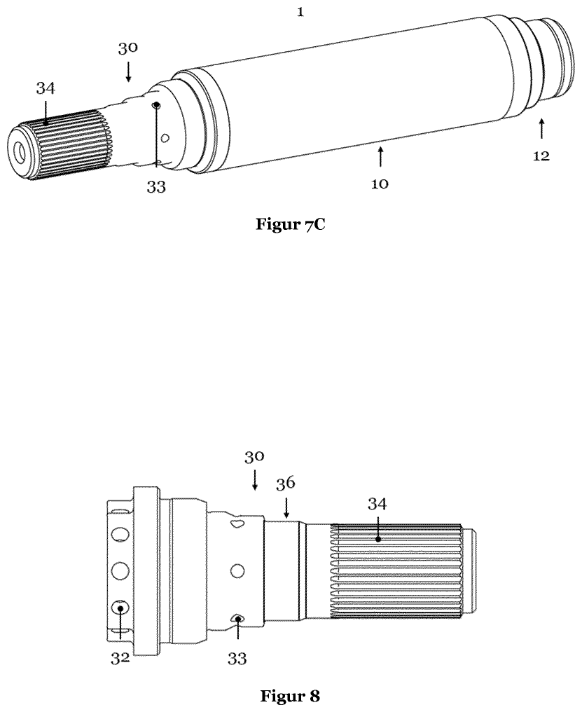

FIG. 8 shows a side view of the first end plug 30 according to the exemplary embodiment illustrated in FIG. 7B. The exemplary first end plug 30 illustrated has a greatly shortened outer profile in comparison with the embodiment of FIG. 2A, since the connection of the first end plug 30 to the casing tube 10 is produced by welding. In addition, the first end plug 30 has a cooling medium distribution structure 32, 33, a fit 36 for a rotary bearing of the electric machine and a torque transmission element 34.

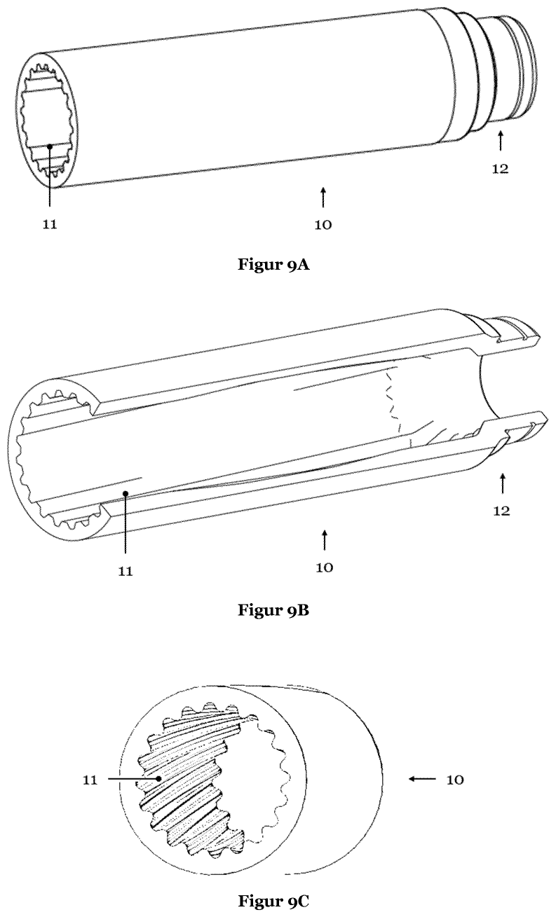

FIG. 9A shows a possible embodiment of a casing tube 10 with an inner profile 11 and a taper 12 at one end of the casing tube 10. In this case, the inner profile is designed such that the longitudinal grooves defined by the inner profile extend helically along the longitudinal axis of the casing tube 10. The angle at which the longitudinal grooves are oriented with respect to the axial direction of the casing tube 10 can be any desired angle at which longitudinal transport of the cooling medium takes place effectively.

FIG. 9B shows a side view of the cut-open casing tube 10 with a taper 12 of FIG. 9A in which the helical profile of the longitudinal grooves of the inner profile 11 is visible.

FIG. 9C shows a possible embodiment of a casing tube 10 with an inner profile 11. In this case, the inner profile is designed such that the longitudinal grooves defined by the inner profile extend helically along the longitudinal axis of the casing tube 10 and thus realize an alternative effective longitudinal transport of the cooling medium. The angle at which the longitudinal grooves are oriented with respect to the axial direction of the casing tube 10 can be any other desired angle at which longitudinal transport of the cooling medium takes place effectively.

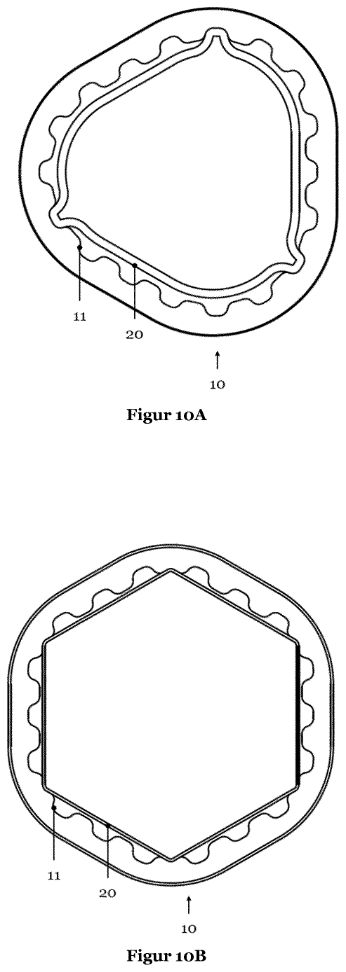

FIG. 10A shows a cross-sectional view through the casing tube 10 and inner tube 20 of a rotor shaft 1 according to a possible embodiment with a profiled inner tube 20 with a cross section with three-fold rotational symmetry. The elevations of the profiling of the inner tube 20 are configured in such a way that they engage in some of the depressions of the inner profile 11 of the casing tube 10. The casing tube 10 is designed in such a way that it likewise has a cross section with three-fold rotational symmetry. The deviation from a circular cross section prevents the relative rotation of inner tube 20 and casing tube 10.

FIG. 10B shows a cross-sectional view through the casing tube 10 and inner tube 20 of a rotor shaft 1 according to a possible embodiment with a hexagonal inner tube 20 and an outer tube, the inner profile of which is configured to bear with its elevations against the outer side of the inner tube. The exemplary inner profile 11 of the casing tube has a profile similar to a sinus along an approximately hexagonal shape of the inner side of the casing tube 10. In the illustrated embodiment, each third elevation of the inner profile 11 of the casing tube 10 is configured to each bear against a corner of the hexagonal inner tube 20. In addition, each of the elevations which each bear against a corner of the inner tube 20 has a central depression in order to receive the corner and thus prevent relative rotation of inner tube 20 and casing tube 10.

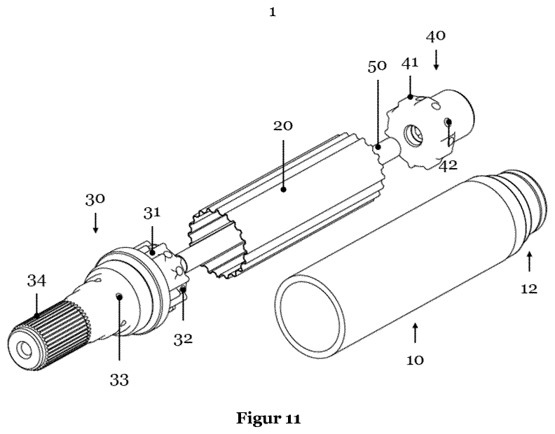

FIG. 11 shows a side view of the components of a rotor shaft 1 according to a possible embodiment of the present disclosure. Said rotor shaft comprises a non-profiled casing tube 10 with a taper 12 at one end of the casing tube 10, for example with a wall thickness in the range from 2.00 mm to 10.00 mm, with a smooth inner side and outer side. The illustrated embodiment additionally comprises a profiled inner tube 20, for example with a wall thickness of 0.5 mm to 5.00 mm, a first end plug 30, a second cooling medium distribution element 40 and a cooling medium guide tube 50. The first end plug 30 can have an outer profile 31 and the second cooling medium distribution element 40 can have an outer profile 41.

In the illustrated embodiment, the second cooling medium distribution element 40 has a cooling medium distribution structure 42 for the cooling medium and the first end plug 30 has the cooling medium distribution structure 32, 33. In the illustrated embodiment, the first end plug 30 further has a torque transmission element 34, via which the rotor shaft 1 can be connected, for example, to a wheel, propeller, transmission or the like to be driven. Other corresponding embodiments can comprise, for example, other outer profiles 31, 41 of the end plugs 30, 40, other cooling medium distribution structures 32, 33, 42 and/or other torque transmission elements 34 and/or can dispense with the use of the cooling medium guide tube 50. At least one of the end plugs 30, 40 can be connected, for example, by welding to the casing tube 10, the inner tube 20 and/or the cooling medium guide tube 50. The taper 12 can be configured in such a way that the second cooling medium distribution element 40 can be at least partially received in the taper 12 of the casing tube 10. The first end plug 30 in the illustrated embodiment is configured to be welded and/or pressed to the casing tube 10 in order to produce a rotationally fixed connection.

FIG. 12A shows a longitudinal section through a rotor shaft 1 according to an embodiment, in which the first end plug or the cooling medium distribution element 30 has an inflow 35 and an outflow 33 for the cooling medium. The profile of the cooling medium in the rotor shaft 1 is illustrated schematically by arrows. The first end plug 30 is present in the illustrated embodiment, as in FIG. 4A. In the exemplary embodiment illustrated in FIG. 12A, the first end plug 30 has an inflow 35, via which the cooling medium is guided in the direction of the arrow in the interior of the first end plug 30. The cooling medium passes through the cooling medium guide tube 50, which, in the illustrated possible embodiment, connects the inflow 35 of the first end plug 30 to the cooling medium distribution structure 42 of the second end plug 40 (also described herein as cooling medium distribution element), into the cooling medium distribution structure 42 along the illustrated arrows. The second cooling medium distribution element 40 is located in the interior of the taper 12 of the casing tube 10, which taper has a fit for a rotary bearing of the electric machine.

The cooling medium distribution structure 42 guides the cooling medium in at least partially radially extending ducts into the axially extending cooling ducts, defined in the free spaces between the casing tube 10 and the inner tube 20. In the exemplary embodiment illustrated, the cooling ducts guide the cooling medium from the second end plug 40 back in the direction of the first end plug 30. The cooling medium distribution structure 32 of the first end plug 30 is connected to the cooling ducts and can guide the cooling medium into the interior of the first end plug 30. The second part of the cooling medium distribution structure 33 of the first end plug 30 represents the outflow for the cooling medium. In this possible embodiment, inflow and outflow of the cooling medium are therefore located at the same end plug 30, which in some embodiments also has a torque transmission element 34.

FIG. 12B shows a longitudinal section through the rotor shaft 1 according to another possible embodiment, in which the first end plug 30 has an inflow 35 for the cooling medium, which is connected to the cooling medium distribution structure 32, and the second end plug 40 has an outflow 45 for the cooling medium, which is connected to the cooling medium distribution structure 42 of the second end plug 40. The first end plug 30 is present in the illustrated embodiment, as in FIG. 4B. The profile of the cooling medium in the rotor shaft 1 is once again illustrated schematically by arrows. In the illustrated embodiment, the cooling medium passes in the direction of the arrow through the inflow 35 into the interior of the first end plug 30. The inflow 35 is connected to the cooling medium distribution structure 32 of the first end plug 30, which guides the cooling medium in at least partially radially extending ducts into the axially extending cooling ducts, defined in the free spaces between the casing tube 10 and the inner tube 20. The cooling ducts guide the cooling medium from the first end plug 30 to the second end plug 40, where it can be guided from the cooling medium distribution structure 42 of the second end plug 40 to the outflow 45. In this possible embodiment, inflow and outflow of the cooling medium are therefore located at different end plugs. The second cooling medium distribution element 40 is located in the interior of the taper 12 of the casing tube 10, the taper 12 having a fit for a rotary bearing of the electric machine.

FIG. 12C shows a longitudinal section through a rotor shaft 1 according to an embodiment, in which the second end plug 40 has an inflow 46 and an outflow 43 for the cooling medium. The profile of the cooling medium in the rotor shaft 1 is once again illustrated schematically by arrows. In the illustrated embodiment, the cooling medium is guided in the direction of the arrow via the inflow 46 into the interior of the second end plug 40. The cooling medium passes through the cooling medium guide tube 50, which, in the illustrated embodiment, connects the inflow 46 of the second end plug 40 to the cooling medium distribution structure 32 of the first end plug 30, into the cooling medium distribution structure 32 of the first end plug 30 along the illustrated arrows. This cooling medium distribution structure 32 guides the cooling medium in at least partially radially extending ducts into the axially extending cooling ducts, defined in the free spaces between the casing tube 10 and the inner tube 20. In the illustrated embodiment, the cooling ducts guide the cooling medium from the first end plug 30 back in the direction of the second end plug 40 (also described herein as cooling medium distribution element). The cooling medium distribution structure 42 of the second end plug 40 is also connected to the axial cooling ducts and can guide the cooling medium into the interior of the second end plug 40. The second cooling medium distribution element 40 is located in the interior of the taper 12 of the casing tube 10, the taper 12 having a fit for a rotary bearing of the electric machine. The cooling medium distribution structure 42 of the second end plug 40 guides the cooling medium to an outflow 43, via which the cooling medium exits from the second end plug 40. In this possible embodiment, inflow and outflow of the cooling medium are therefore located at the second end plug 40. This has the advantage, inter alia, that the first end plug 30, which has the torque transmission element 34, requires no connections for the cooling medium, which can lead, inter alia, to improved mechanical properties of the first end plug 30 and space saving for an electric drive system—for example a direct drive for motor vehicle wheels or a drive for an aircraft propeller—in which such an actively cooled rotor shaft 1 is used.

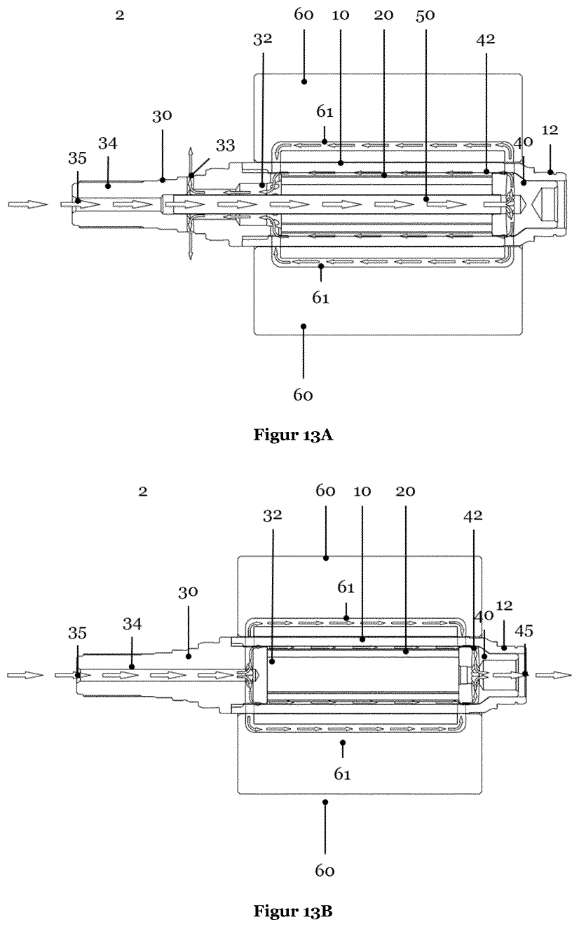

FIG. 13A shows a longitudinal section through the embodiment of a rotor shaft 1, in which the first end plug 30 has the inflow 35 and the outflow 33 for the cooling medium and an element for electromagnetic force transmission 60 which is connected in a rotationally fixed manner, preferably in a force-fitting manner, to a part of the outer surface of the casing tube 10. The profile of the cooling medium in the rotor shaft 1 and in the element for electromagnetic force transmission 60 is once again illustrated schematically by arrows. The rotor shaft 1 together with the element for electromagnetic force transmission 60, which can have dedicated cooling ducts 61, represents a rotor 2 of a rotating electric machine 3. In the possible embodiment illustrated in FIG. 13A, the cooling medium can pass via the inflow 35 into the first end plug 30. The cooling medium passes through a cooling medium guide tube 50, which, in the illustrated possible embodiment, connects the inflow 35 of the first end plug 30 to the cooling medium distribution structure 42 of the second end plug 40, into the cooling medium distribution structure 42 of the second end plug 40 along the illustrated arrows. The second cooling medium distribution element 40 is located in the interior of the taper 12 of the casing tube 10, the taper 12 having a fit for a rotary bearing of the electric machine. The cooling medium distribution structure 42 guides the cooling medium in at least partially radially extending ducts into the axially extending cooling ducts, defined in the free spaces between the casing tube 10 and the inner tube 20, and into the cooling ducts 61 of the element for electromagnetic force transmission 60. The cooling medium can pass via the cooling ducts from the second end plug 40 to the first end plug 30, where it can be received by the cooling medium distribution structure 32 of the first end plug 30 and guided to the outflow 33. In this possible embodiment, inflow and outflow of the cooling medium are therefore located at the same end plug.

FIG. 13B shows a longitudinal section through the embodiment of the rotor shaft 1, in which the first end plug 30 has an inflow 35 for the cooling medium, which is connected to the cooling medium distribution structure 32 of the first end plug 30, and the second end plug 40 has an outflow 45 for the cooling medium, which is connected to the cooling medium distribution structure 42, and an element for electromagnetic force transmission 60, which is connected in a rotationally fixed manner, preferably in a force-fitting manner, to a part of the outer surface of the casing tube 10. The profile of the cooling medium in the rotor shaft and in the element for electromagnetic force transmission is illustrated schematically by arrows. The rotor shaft 1 together with the element for electromagnetic force transmission 60, which can have dedicated cooling ducts 61, represents the rotor 2. The cooling medium can pass via all cooling ducts from the first end plug 30 to the second end plug 40, where it can be received by the cooling medium distribution structure 42 of the second end plug 30 and guided to the outflow 45. In this possible embodiment, inflow and outflow of the cooling medium are therefore located at different end plugs. The second cooling medium distribution element 40 is located in the interior of the taper 12 of the casing tube 10, the taper 12 having a fit for a rotary bearing of the electric machine.

In the exemplary embodiments of FIGS. 12A to 13B, the first end plug 30 is of identical construction analogously to FIGS. 4A-5C and is connected to the casing tube 10 by pressing, while the embodiments differ in the design of the cooling medium distribution element 40. This can be realized either as an end plug 40 (FIGS. 4A-5C) or as a cooling medium distribution element 40 which is at least partially received by the taper 12 of the casing tube 10.

### Further Exemplary Embodiments

Further possible embodiments are described below:
1. Rotor shaft for a rotor of an electric machine, comprising:
   a casing tube which has an inner profile with a plurality of longitudinal grooves;
   an inner tube which is arranged in the interior of the casing tube; and
   a first and a second end plug which are each connected to one end of the casing tube in a form-fitting and force-fitting or form-fitting and integrally bonded manner by engaging in a part of the plurality of longitudinal grooves;
   wherein the inner profile of the casing tube and the outer side of the inner tube define a plurality of cooling ducts through which a cooling medium can flow along the casing tube.
2. Rotor shaft according to Embodiment 1, wherein at least one of the two end plugs has a torque transmission element.
3. Rotor shaft according to one of Embodiments 1 or 2,
   wherein the inner profile of the casing tube along the circumference of the casing tube has periodically repeating elevations and depressions.
4. Rotor shaft according to one of Embodiments 1 to 3,
   wherein the inner tube engages in a part of the plurality of longitudinal grooves.
5. Rotor shaft according to Embodiment 4, wherein the inner tube has a cross section with elevations and depressions periodically repeating along its circumference and the elevations engage in the part of the longitudinal grooves of the inner profile of the casing tube.
6. Rotor shaft according to one of the preceding Embodiments 1 to 5,
   wherein the casing tube has a wall thickness in the range from 2.00 mm to 10.00 mm; and/or
   wherein the inner tube has a wall thickness in the range from 0.5 mm to 5.00 mm.
7. Rotor shaft according to one of the preceding Embodiments 1 to 6, wherein the inner profile of the casing tube has a profile depth in the range from 1.00 mm to 6.00 mm, preferably in the range from 1.5 mm to 3.5 mm, and/or
   wherein the inner tube has a profile depth in the range from 0.5 mm to 4.00 mm, preferably in the range from 1.5 mm to 3.5 mm.
8. Rotor shaft according to one of the preceding Embodiments 1 to 7,
   wherein one or both of the end plugs has an outer profile which engages in the inner profile of the casing tube; and/or
   wherein the end plugs are pressed to the casing tube; and/or
   wherein the end plugs are welded to the casing tube.
9. Rotor shaft according to one of the preceding Embodiments 1 to 8,
   wherein the end plugs each have a cooling medium distribution structure which is connected to one of the cooling ducts defined via the inner profile of the casing tube and the outer side of the inner tube.
10. Rotor shaft according to Embodiment 9,
   wherein one of the end plugs has an inflow for the cooling medium, which is connected to the cooling medium distribution structure, and the other end plug has an outflow for the cooling medium, which is connected to the cooling medium distribution structure.
11. Rotor shaft according to Embodiment 9, further comprising
   a cooling medium guide tube which is arranged within the inner tube and connects the two end plugs to one another in such a way that the cooling medium can flow from one end plug to the other through the cooling medium guide tube; and
   wherein one of the end plugs has an inflow and an outflow for the cooling medium, wherein the outflow is connected to the cooling medium distribution structure and the inflow is connected to the cooling medium guide tube.
12. Rotor shaft according to Embodiment 2 and Embodiment 10 or Embodiment 11, wherein the end plug, which has the inflow for the cooling medium, also has the torque transmission element.
13. Rotor for an electric machine, comprising:
   a rotor shaft according to one of the preceding Embodiments 1 to 12; and
   an element for electromagnetic force transmission which is connected in a rotationally fixed manner, preferably in a force-fitting manner, to a part of the outer surface of the casing tube.
14. Rotor according to Embodiment 13, comprising a rotor shaft according to one of Embodiments 9 to 12, wherein the element for electromagnetic force transmission has at least one cooling duct which is connected to the cooling medium distribution structure of the two end plugs.
15. Electric machine, comprising:
   a stator; and
   a rotor according to one of the preceding Embodiments 13 or 14.

1. Rotor shaft (1) for a rotor of an electric machine (3), comprising:
a casing tube (10);
an inner tube (20) which is arranged in the interior of the casing tube; and
two cooling medium distribution elements (30, 40) which are each arranged at one end of the rotor shaft;
wherein the casing tube has an inner profile (11) with a plurality of longitudinal grooves and/or the inner tube has an outer profile with a plurality of longitudinal grooves; and
wherein the inner profile of the casing tube and/or the outer profile of the inner tube define a plurality of cooling ducts through which a cooling medium can flow along the rotor shaft from one cooling medium distribution element to the other cooling medium distribution element.

2. Rotor shaft according to claim 1, wherein at least one of the two cooling medium distribution elements has a torque transmission element (34).

3. Rotor shaft according to one of the preceding claims,
wherein the inner profile of the casing tube along the circumference of the casing tube and/or the outer profile of the inner tube along the circumference of the inner tube has periodically repeating elevations and depressions.

4. Rotor shaft according to one of the preceding claims,
wherein the inner tube engages in a part of the plurality of longitudinal grooves of the inner profile of the casing tube.

5. Rotor shaft according to the preceding claim 4, wherein the inner tube has a cross section with elevations and depressions periodically repeating along its circumference and the elevations engage in the part of the longitudinal grooves of the inner profile of the casing tube.

6. Rotor shaft according to one of the preceding claims,
wherein the casing tube has a wall thickness in the range from 2.00 mm to 10.00 mm; and/or
wherein the inner tube has a wall thickness in the range from 0.5 mm to 5.00 mm.

7. Rotor shaft according to one of the preceding claims, wherein the inner profile of the casing tube has a profile depth in the range from 1.00 mm to 6.00 mm, preferably in the range from 1.5 mm to 3.5 mm, and/or
wherein the inner tube has a profile depth in the range from 0.5 mm to 4.00 mm, preferably in the range from 1.5 mm to 3.5 mm.

8. Rotor shaft according to one of the preceding claims, wherein the cooling medium distribution elements are each connected to one end of the casing tube in a form-fitting and force-fitting or form-fitting and integrally bonded manner by engaging in a part of the plurality of longitudinal grooves.

9. Rotor shaft according to claim 8,
wherein one or both of the cooling medium distribution elements have an outer profile (31, 41) which engages in the inner profile of the casing tube; and/or
wherein one or both of the cooling medium distribution elements are pressed to the casing tube; and/or
wherein one or both of the cooling medium distribution elements are welded to the casing tube.

10. Rotor shaft according to one of the preceding claims,
wherein the cooling medium distribution elements each have a cooling medium distribution structure (32, 33, 42) which is connected to one or more of the cooling ducts defined via the inner profile of the casing tube and/or via the outer profile of the inner tube.

11. Rotor shaft according to claim 10,
wherein one of the cooling medium distribution elements has an inflow (35) for the cooling medium, which is connected to the associated cooling medium distribution structure, and the other cooling medium distribution element has an outflow (45) for the cooling medium, which is connected to the associated cooling medium distribution structure.

12. Rotor shaft according to claim 10, further comprising
a cooling medium guide tube (50) which is arranged within the inner tube and connects the two cooling medium distribution elements to one another in such a way that the cooling medium can flow from one cooling medium distribution element to the other through the cooling medium guide tube; and
wherein one of the cooling medium distribution elements has an inflow (35) and an outflow for the cooling medium, wherein the outflow is connected to the associated cooling medium distribution structure and the inflow is connected to the cooling medium guide tube.

13. Rotor shaft according to claim 2 and claim 11 or 12, wherein the cooling medium distribution element, which has the inflow for the cooling medium, also has the torque transmission element.

14. Rotor shaft according to claim 2 and claim 12, wherein the cooling medium distribution element, which has the torque transmission element, has neither an inflow nor an outflow for the cooling medium.

15. Rotor shaft according to one of the preceding claims, wherein the casing tube has, at least at one end, a fit for a rotary bearing of the electric machine.

16. Rotor shaft according to claim 15, wherein the casing tube has, at least at one end, a taper which is designed to receive the cooling medium distribution element in the interior of the casing tube and to function as the running surface for the rotary bearing of the electric machine.

17. Rotor for an electric machine, comprising:
a rotor shaft according to one of the preceding claims 1 to 16; and
an element for electromagnetic force transmission which is connected in a rotationally fixed manner, preferably in a force-fitting manner, to a part of the outer surface of the casing tube.

18. Rotor according to claim 17, comprising a rotor shaft according to one of the preceding claims 10 to 16, wherein the element for electromagnetic force transmission has at least one cooling duct which is connected to the cooling medium distribution structure of the two cooling medium distribution elements.

19. Electric machine, comprising:
a stator; and
a rotor according to one of claims 17 or 18.
